(19) United States
(12) Patent Application Publication
(10) Pub. No.: US 2013/0074728 A1
(43) Pub. Date: Mar. 28, 2013

(54) METAL MICROPARTICLES AND METHOD FOR PRODUCING THE SAME, METAL PASTE CONTAINING THE METAL MICROPARTICLES, AND METAL COAT MADE OF THE METAL PASTE

(71) Applicant: HITACHI CABLE, LTD., Tokyo (JP)

(72) Inventors: Dai ISHIKAWA, Tsukuba-shi (JP); Tomiya ABE, Hitachi-shi (JP)

(73) Assignee: HITACHI CABLE, LTD., Tokyo (JP)

(21) Appl. No.: 13/626,520

(22) Filed: Sep. 25, 2012

(30) Foreign Application Priority Data
Sep. 26, 2011 (JP) 2011-209524

(51) Int. Cl. B32B 15/02; B05D 7/00; C08L 91/00; C09D 201/00; C09D 5/00; C09D 199/00

(52) U.S. Cl. 106/217.6; 106/287.18; 106/243; 106/285; 427/216; 428/402.24

(57) ABSTRACT

To provide metal microparticles, with less content of alkali metal, halogen, sulfur, and phosphorus as impurities, wherein surfaces thereof are coated with a protective agent, and the protective agent is selected from at least one type of an amine compound and a calboxylic acid compound, and a total content of the alkali metal, halogen, sulfur, and phosphorus contained in the metal microparticles is less than 0.1 mass % relative to a mass of the metal microparticles.

The present application is based on Japanese Patent Application No. 2011-209524 filed on Sep. 26, 2012, the entire contents of which are hereby incorporated by reference.

### BACKGROUND

1. Technical Field

The present invention relates to metal microparticles and a method for producing the same, a metal paste containing the metal microparticles, and a metal coat made of the metal paste.

2. Description of Related Art

The metal paste is used as a plating alternative material and a fine wiring material for example. The metal paste contains the metal microparticles and a solvent composition, etc., and the metal paste is a material to become a metal coat by being sintered.

The method for producing metal microparticles is roughly classified into three types such as a solid phase method, a vapor phase method, and a liquid phase method.

The solid phase method is a method of pulverizing a metal powder by performing mechanical milling process and a mechanical alloying process, to produce metal microparticles or an alloy fine particle (for example, see patent document 1 and non-patent document 1). According to the solid phase method, the metal powder is mixed into a ball-shaped ceramics powder with high solidity, and a vessel with such a mixture put therein is rotated at high speed so that particles collide each other that the metal powder is crushed by mechanical energy, to thereby obtain the metal microparticles.

The vapor phase method is a method of vaporizing a metal ingot in a vacuum chamber, so that a steam of a protective agent for preventing cohesion of the metal microparticles is brought into contact with a gas of a vaporized metal, and is cooled to thereby produce the metal microparticles (for example, see patent document 2). According to the vapor phase method, the metal microparticles with less impurities and high purity can be obtained.

The liquid phase method is a method of reducing metal ions in a liquid phase, and making a metal nucleus grow little by little, to thereby produce the metal microparticles (for example, see patent document 3). In the liquid phase method, a metal compound is previously dissolved into the liquid phase containing a reducing agent and a protective agent, to thereby adjust the liquid phase in which the metal ions are uniformly present. By the reducing agent contained in the liquid phase, electrons are given to the metal ions, to thereby generate the metal nucleus. Then, generated metal nucleuses are agglutinated to grow the metal nucleus, to thereby generate the metal microparticles. More specifically, the metal compound (such as halogen, and metal salt containing S or P) is dissolved into the liquid phase, which is then reduced by the reducing agent (including halogen, S, P, or alkali metal), so that the metal microparticles are precipitated. According to such a liquid phase method, the metal microparticles can be produced at a low cost with a simple apparatus structure, compared with the vapor phase method.

However, the aforementioned three types of methods involve problems respectively.

The solid phase method has a problem that minute metal microparticles are hardly obtained, and purity of the produced metal microparticles is low. A particle size of the metal microparticles produced by the solid phase method is influenced by a size of a ball-shaped ceramics powder used for pulverization. Usually, it is difficult to produce the minute metal microparticles at high yield, with the size of the industrially used ball-shaped ceramics powder. Further, when the metal powder and the ceramics powder collide each other, not only the metal powder, which is a target to be pulverized, but also the ceramics powder is pulverized. Therefore, mixture of ceramics into the metal microparticles cannot be prevented in principle, thus lowering the purity of the metal microparticles.

The vapor phase method has a problem that although the metal microparticles with high purity is obtained, the apparatus structure is complicated, thus increasing a production cost. The vapor phase method requires a vacuum system and a chamber, and an apparatus for plasma and electron beam, laser, and induction heating as an energy source for vaporizing the metal ingot. Such devices are generally expensive. Further, in the vapor phase method, a production amount of the metal microparticles per reactor volume and reaction time is low. In addition, if a plurality of types of metal microparticles are produced by one production apparatus, a certain metal microparticles becomes an impurity of other metal microparticles, and therefore it is necessary that one type of metal microparticles is produced by one apparatus. As described above, the vapor phase method has a problem that an apparatus is expensive and a production amount is low, and therefore a production cost is extremely high, compared with other production method.

The liquid phase method has a problem that the production cost of the metal microparticles is high, although which is not as high as the production cost of the vapor phase method, and the purity of the produced metal microparticles is low. In the liquid phase method, the apparatus is generic compared with the apparatus of the vapor phase method, and an initial facility cost and a running cost are low. However, from an industrial viewpoint, a production speed and a production amount are insufficient, thus increasing the production cost as a result. The reason is as follows. Namely, the liquid phase method is the method of growing the metal nucleus while introducing circumferential metal ions to the metal nucleus generated in the liquid phase. Then, by suppressing the growth of the metal nucleus, the metal microparticles having a minute size can be obtained. In order to suppress the growth, concentration of the metal ions that exist around the metal nucleus is reduced, to thereby suppress introduction of the metal ions. This shows relative increase of the solution (liquid waste) not contributing to a reaction while reducing a metal concentration in a reaction system. As a result, in the liquid phase method, production efficiency is lowered and the liquid waste is increased. Namely, in the liquid phase method, although the facility cost is inexpensive, a production amount of the metal microparticles per reaction volume is small. Therefore, in the liquid phase method, the production cost of the metal microparticles is increased as a result, although it is not so high as the production cost of the vapor phase method.

Further, in the liquid phase method, cation (such as ion of alkali metal) derived from a composition of the liquid phase such as the reducing agent, and anion derived from the metal compound of a raw material (such as halide ion, sulfate ion, and phosphate ion, etc.) are remained in the liquid phase after precipitation of the metal microparticles. Such residues are hardly removed, and therefore are included in the produced metal microparticles as impurities, thus lowering the purity of the metal microparticles. Property of the metal microparticles is deteriorated, with a mixture of the impurities.

Meanwhile, the liquid phase method includes a method (complex decomposing method) using a metal complex for the metal compound of the raw material, as the method of solving a low metal ion concentration in the solution (for example, see patent document 4). The complex decomposing method is the method of thermally decomposing the metal complex in a solvent containing a protective agent, to thereby precipitate the metal microparticles. According to the complex decomposing method, owing to a high metal ion concentration during synthesis, the production speed is high and the metal microparticles can be produced at a low cost.

Patent document 1:
Japanese Patent Laid Open Publication No. 2005-314806

Patent document 2:
Japanese Patent Laid Open Publication No. 2002-121606

Patent document 3:
Japanese Patent Laid Open Publication No. 1993-117726

Patent document 4:
Japanese Patent Laid Open Publication No. 2007-63579 Non-patent document 1
S. Sheibani et al., Mater. Lett., (2006)

However, in the aforementioned patent document 4, the metal complex containing unnecessary elements (such as alkali metal, halogen, sulfur, and phosphorus) is used, and therefore the unnecessary elements are remained on the metal microparticles as impurities, thus deteriorating the property of the produced metal microparticles. Such impurities are hardly removed, and the purity of the metal microparticles is lowered by such residual impurities. The metal microparticles with low purity have a poor property, and if such metal microparticles are used for the metal paste, conductivity of a formed metal coat (such as volume resistance rate) is also poor. Further, the step of preparing the metal complex is required, and therefore by adding such a step, a low yield and increase the cost are inevitably invited. Thus, in patent document 4, although the production cost of the metal microparticles can be reduced to some degree, the property of the obtained metal microparticles is insufficient.

### SUMMARY OF THE INVENTION

In view of the above-described problem, the present invention is provided, and an object of the present invention is to provide metal microparticles with less content of impurities, and further to provide a metal paste containing the metal microparticles and having excellent sintering property, and a metal coat made of the metal paste and having excellent conductivity.

According to a first aspect of the present invention, there is provided metal microparticles with surfaces coated with a protective agent, wherein the protective agent is selected from at least one type of an amine compound and a carboxylic acid compound, and a total content of alkali metal, halogen, sulfur, and phosphorus contained in the metal microparticles is less than 0.1 mass % relative to a mass of the metal microparticles.

According to a second aspect of the present invention, there is provided the metal microparticles according to the first aspect, wherein the protective agent is composed of an amine compound and a calboxylic acid compound.

According to a third aspect of the present invention, there is provided the metal microparticles according to the first aspect, wherein the amine compound is an aliphatic amine compound represented by a general formula NH₂R¹, NHR¹R², or NR¹R²R³, in which R¹, R², and R³ indicate carbon numbers 2 to 16.

According to a fourth aspect of the present invention, there is provided the metal microparticles according to the first aspect, wherein the metal microparticles are composed of at least one type of gold, silver, copper, platinum, or palladium.

According to a fifth aspect of the present invention, there is provided a metal paste containing the metal microparticles of the first aspect and a solvent composition.

According to a sixth aspect of the present invention, there is provided the metal paste of the fifth aspect, wherein the solvent composition is selected from one type of water, alcohols, aldehydes, ethers, esters, amines, monosaccharide, straight-chain hydrocarbon, fatty acids, and aromatics, or a combination of them.

According to a seventh aspect of the present invention, there is provided a metal coat, which is formed by sintering the metal paste of the fifth aspect.

According to an eighth aspect of the present invention, there is provided a method for producing metal microparticles, comprising the steps of:

reducing and precipitating a metal nucleus from a metal compound dispersed in a solid state, in a liquid phase containing a reducing agent and a protective agent, and agglutinating the metal nucleus, and coating the metal nucleus with the protective agent, and generating metal microparticles; and

removing alkali metal, halogen, sulfur, and phosphorus, being impurities contained in the metal microparticles;

wherein at least one type of an amine compound and a calboxylic acid compound not containing the impurities is used in the generating step, as the reducing agent and the protective agent, and

a mixed solvent of water and an organic solvent is used in the purifying step,

so that a total content of the impurities is less than 0.1 mass % relative to a mass of the metal microparticles.

According to a ninth aspect of the present invention, there is provided the method for producing metal microparticles according to the eighth aspect, wherein the amine compound and the calboxylic acid compound not containing the impurities are used in the generating step, as the protective agent.

According to a tenth aspect of the present invention, there is provided the method for producing metal microparticles according to the eighth aspect, wherein the metal compound is a metal oxide.

### BRIEF DESCRIPTION OF THE DRAWINGS

FIG. 1 is a view of an XRD measurement result of Au metal microparticles according to example 1 of the present invention.

FIG. 2 is a view of GC-MS measurement results of the Au fine particle according to example 1 of the present invention.

FIG. 3 is a view of NMR measurement results of the Au metal microparticles according to example 1 of the present invention.

FIG. 4 is a FE-SEM photograph of the Au metal microparticles according to example 1 of the present invention.

FIG. 5 is a view of XRD measurement results of Ag metal microparticles according to example 2 of the present invention.

FIG. 6 is a FE-SEM photograph of the Ag metal microparticles according to example 2 of the present invention.

FIG. 7 is a view of XRD measurement results of Cu metal microparticles according to example 5 of the present invention.

FIG. 8 is a FE-SEM photograph of the Cu metal microparticles according to example 5 of the present invention.

### DETAILED DESCRIPTION OF THE EMBODIMENTS OF THE INVENTION

As described above, in the conventional liquid phase method (including the complex decomposing method), a metal compound is previously dissolved in a liquid phase to obtain a homogeneous metal ion solution, and in this liquid phase, metal ions are reduced. A metal nucleus generated by such a reduction are agglutinated and grown, to thereby form metal microparticles. When the metal nucleus generated in the liquid phase becomes the metal microparticles, two repulsive reactions occur. One of them is a nucleus growth reaction by agglutination of the generated metal nucleus, and by this reaction, the metal microparticles are formed from metal nucleuses. The other one is a nucleus growth suppressing reaction by adsorption of a protective agent in a liquid phase on the metal nucleus, and by this reaction, the nucleus growth is suppressed, and a size of each metal microparticle is controlled. In the liquid phase method, the aforementioned two reactions occur, and a particle size of the finally formed metal microparticle is changed, depending on a priority which reaction is selected. If the nucleus growth reaction of the metal nucleus is faster, the formed metal microparticles are coarsened. On the contrary, if the nucleus growth reaction of the metal nucleus is relatively slower, the formed metal microparticles become finer.

In a conventional liquid phase method, the nucleus growth reaction out of the two reactions is relatively faster, and therefore the formed metal microparticles become coarse. The reason is as follows. Namely, in the conventional liquid phase method, the metal compound is previously dissolved in the liquid phase, and the metal ions exit homogeneously in the whole liquid phase. If the metal ions are reduced, the metal nucleus is generated in the whole liquid phase. Therefore, there is a high probability that other metal nucleus exists around a certain metal nucleus. Metal nucleuses close to each other are mutually agglutinated to grow into a larger metal nucleus. Namely, an action of nucleus agglutination and growth of the nucleus, is larger than an action of the protective agent for suppressing the nucleus growth. As a result, coarse metal microparticles are formed.

In addition, impurities (including alkali metal, halogen, sulfur, and phosphorus) derived from raw materials (such as metal compound and reducing agent) are contained in the formed metal microparticles. This is because in order to prepare a homogeneous metal ion solution by dissolving the metal compound, metal salt containing halogen, or a metal complex containing halogen, sulfur, and phosphorus are used. Further, this is because the reducing agent containing alkali metal such as Na is used. Then, by containing the impurities, property of the metal microparticle is deteriorated, thus lowering the conductivity of a metal coat made of the metal microparticles.

Therefore, inventors of the present invention pay attention to a method of precipitating the metal microparticles by a reductive reaction in a heterogeneous solid-liquid system in which the metal compound (solid body) and a liquid phase coexist (called a heterogeneous solid-liquid method hereafter).

The heterogeneous solid-liquid method is considered to be one of the liquid phase methods, in a point that the metal ions are reduced in the liquid phase to thereby precipitate the metal microparticles. However, the heterogeneous solid liquid method is different from the conventional liquid phase method in a point that the conventional liquid phase method is the method of previously dissolving the metal compound and precipitating the metal microparticles in the liquid phase which is prepared in a homogeneous metal ion solution, and meanwhile a different point of the heterogeneous solid-liquid method is the point that the metal microparticles are not allowed to dissolve into the liquid phase, and the metal compound dispersed in the liquid phase in a solid state is reduced so that the metal microparticles are precipitated.

More specifically, the heterogeneous solid-liquid system is prepared in a coexistence state of the liquid phase containing the reducing agent and the protective agent, and the metal compound which is insoluble in the liquid phase. This system is heated to cut a chemical bond (ionic bond and coordinate bond) of metal atoms in the metal compound, so that the metal ions are generated from the surface of the metal compound. The metal ions are reduced by the reducing agent in the liquid phase on the surface of the metal compound before dispersing into the whole liquid phase, to become a metal nucleus. The metal nucleus precipitated from the surface of the metal compound, grows to become the metal microparticles by agglutination of nucleuses. Thus, according to the heterogeneous solid-liquid method, a reductive reaction of the metal ions and generation of the metal nucleus are generated on an interface between the metal compound and the liquid phase, to thereby precipitate the metal microparticles.

In the heterogeneous solid-liquid method, in order to generate the metal nucleus from the metal compound, it is necessary that the chemical bond of the metal atoms in the metal compound is cut by an action of the reducing agent so that the metal ions are generated, to thereby reduce the metal ions. Therefore, a generation speed of the metal nucleus in the heterogeneous solid-liquid method becomes slow, compared with a reaction of the conventional liquid phase method in which the metal ions dispersed in the liquid phase become the metal nucleus. Further, the generation of the metal nucleus is limited to the interface between the metal compound (solid body) and the liquid phase. Namely, in the generation of the metal nucleus in the solid-liquid system, the generation of the metal nucleus itself is slow, and is spatially limited. Therefore, there is a low probability that other metal nucleus exists around a certain metal nucleus. As a result, the nucleus growth reaction by agglutination of the metal nucleuses is suppressed and a nucleus growth suppressing reaction of the metal nucleuses occurs by the protective agent, to thereby make the particle size minute, which is the particle size of a finally formed metal microparticles.

Further, according to the heterogeneous solid-liquid method, there is no necessity for using a specific metal salt containing halogen or a specific reducing agent containing alkali metal, because the metal compound is not dissolved in the liquid phase. Therefore, a mixture amount of the impurities derived from the raw material can be reduced.

The inventors of the present invention evaluate the property of the metal microparticles by forming the metal microparticles using the raw material containing less amount of impurities, based on the aforementioned heterogeneous solid-liquid method. However, the evaluation of the property is insufficient yet. After examination of this result, it is found that even in a case of the raw material not containing the impurities as components (for example, such as metal oxide), an extremely small amount of impurities are contained, and the formed metal microparticles has the impurities mixed therein. More specifically, when gold oxide (Au₂O₃) not containing an impurity (Cl) as a composition is synthesized from gold chloride (AuCl₃), an extremely small amount of Cl is contained. Then, it is found that an extremely small amount of impurity is mixed into the metal microparticles, and the property of the metal microparticle is deteriorated. This reveals that it is difficult to completely prevent the mixture of the impurities derived from the raw material.

Therefore, the inventors of the present invention pay attention to a purifying step of the metal microparticles, and after strenuous efforts regarding a removing method of the contained impurities, it is found that the amount of impurities contained in the metal microparticles can be further reduced by purifying the metal microparticles with less amount of impurities obtained by the heterogeneous solid-liquid method, by a mixed solvent of water and organic solvent, to thereby achieve the present invention.

### (A Method for Producing Metal Microparticles)

A method for producing metal microparticles according to an embodiment of the present invention will be described hereafter. The aforementioned heterogeneous solid-liquid method is used in the method for producing metal microparticles according to this embodiment.

The method for producing metal microparticles of this embodiment includes the steps of: reducing and precipitating a metal nucleus from a metal compound dispersed in a solid state, in a liquid phase containing a reducing agent and a protective agent, and agglutinating the metal nucleus, and coating the metal nucleus with the protective agent, and generating metal microparticles; and removing alkali metal, halogen, sulfur, and phosphorus, being impurities contained in the metal microparticles.

First, the liquid phase containing the reducing agent and the protective agent is prepared.

Owing to the protective agent, the growth of the metal microparticles is suppressed by suppressing the agglutination of the generated metal nucleus, and the agglutination and fusion of the metal microparticles are suppressed by coating and stabilizing the surfaces of the formed metal microparticles. Namely, the metal microparticles are made finer and stabilized by coating, owing to the protective agent. According to this embodiment, at least one type of an amine compound and a carboxylic acid compound is used as the protective agent.

The amine compound is a compound having an amine group (—NH₂) showing a basic property as a functional group containing nitrogen having covalent electron pair. The amine compound shows an adsorption property through a coordinate bond to the surfaces of the metal microparticles, and has an action of reducing the metal compound by an action of non-covalent electron pair on a nitrogen atom. Namely, the amine compound has both roles of the protective agent and the reducing agent. As the amine compound, a compound having a reduction power required for reducing the metal compound can be used. The amine compound is constituted of carbon, nitrogen, hydrogen, and oxygen, etc., and does not contain alkali metal, halogen, sulfur, or phosphorus, and therefore impurities containing them are not formed.

As the amine compound, an aliphatic amine compound is preferably used, which is represented by a general formula NH₂R¹, NHR¹R², or NR¹R²R³ (R¹, R², and R³ in the formula are an alkyl group with carbon number of 2 to 16). The aliphatic amine compound shows a coordinate adsorption property on the metal microparticles, and has an electron donative alkyl group, to thereby increase an electron density of the non-covalent electron pair on the nitrogen atom, and has a high reducibility. The reducibility of the aliphatic amine compound depends on strong/weak of the electron density of the non-covalent electron pair on the nitrogen atom. Generally, as the electron donative alkyl group is increased, the electron density of the non-covalent electron pair on the nitrogen atom becomes high, and the reducibility also becomes high. Therefore, a secondary amine compound and a tertiary amine compound have stronger reducibility than the reducibility of a primary amine compound. Regarding the reproducibility of the secondary amine compound and the tertiary amine compound, a three-dimensional factor of the alkyl group is also concerned in addition to the electron density derived from the number of alkyl groups. Therefore, strong/weak of the reducibility is not clear, and the amine compound having high ability to reduce the metal compound in experiment may be selected.

The amine compound includes for example, butylamine, pentylamine, hexylamine, cyclohexylamine, octylamine, laurylamine, stearylamine, oleylamine, benzylamine, dipentylamine, dihexylamine, bis(2-ethylhexyl)amine, dicyclohexylamine, dioctylamine, dilaurylamine, distearylamine, dioleylamine, dibenzylamne, stearylmonoethanolamine, decylmonoethanolamine, hexylmonopropanolamine, benzylmonoethanolamine, phenylmonoethanolamine, tolylmonopropanolamine, tripropylamine, tributylamine, tripentylamine, trihexylamine, tricyclohexylamine, trioctylamine, trilaurylamine, tristearylamine, trioleylamine, tribenzylamine, dioleylmonoethanolamine, dilaurylmonopropanolamine, dioctylmonoethanolamine, dihexylmonopropanolamine, dibutylmonopropanolamine, oleyldiethanolamine, stearyldipropanolamine, lauryldiehtanolamine, octyldipropanolamine, butyldiethanolamine, bezyldiethanolamine, phenyldiethanolamine, tolyldipropanolamine, xylyldiethanolamine, triethanolamine, tripropanolamine, etc., and two types or more different amine compounds may be combined and used.

Calboxylic acid compound is a compound having a calboxyl group (—COOH) showing acidity as a functional group including oxygen having non-covalent electron pair. The calboxylic acid compound shows a coordinate adsorption property to the surface of the metal microparticles, by an action of the non-covalent electron pair on the oxygen atom. The calboxylic acid does not contain alkali metal, halogen, sulfur, or phosphorus, and therefore the impurities containing them are not included in the formed metal microparticles.

The calboxylic acid that can be used for the protective agent includes for example, formic acid, acetic acid, propionic acid, butyric acid, valeric acid, caproic acid, caprylic acid, enanthic acid, pelargonic acid, lauric acid, myristic acid, palmitic acid, margaric acid, stearic acid, oleic acid, linoleic acid, linolenic acid, malonic acid, succinic acid, glutaric acid, adipic acid, pimelic acid, suberic acid, azelaic acid, sebacic acid, dodecanedioic acid, fumaric acid, maleic acid, phthalic acid, terephthalic acid, isophthalic acid, diphenylethel-4,4′-dicalboxylic acid, butane-1,2,4-tricarboxylic acid, cyclohexan-1,2,3-tricalboxylic acid, benzene-1,2,4-tricalboxylic acid, naphthalin-1,2,4-tricalboxylic acid, butane-1.2.3.4-tetracalboxylic acid, cyclobutane-1,2,3,4-tetraclboxylic acid, benzene-1,2,4,5-tetracalboxylic acid, 3,3′,4,4′-benzophenontetracalboxylic acid, 3,3′,4,4′-diphenyletheltetracalboxylic acid, etc., and two types or more different calboxylic acid compounds may be combined and used.

An addition amount of the protective agent is set so that a value of the metal concentration falls within a range of 1 to 90 mass %. Wherein, the metal concentration is defined by the following formula.

Metal concentration (mass %)=metal mass (g)×100(mass %)/mass of reaction solution (g)

In the above formula, the reaction solution shows the liquid phase containing the metal compound, wherein the reducing agent, the protective agent, or the solvent, etc., is included in the liquid phase other than the metal compound in some cases. Low metal concentration indicates a low amount of formed metal microparticless and a small amount of production in the reaction solution.

The addition amount of the protective agent required for coating the surfaces of the formed metal microparticles is calculated and determined. Namely, when it is assumed that a prescribed amount of metal particles having a prescribed particle size is generated, the addition amount of the protective agent can be determined in consideration of an adsorption area of the protective agent required for covering the surface area of the metal microparticles. When the protective agent is used as the reducing agent (for example, when the amine compound is used as the reducing agent), the addition amount is determined in consideration of the amount required for reducing the metal compound. At this time, the aforementioned formula is suitably adjusted so that the metal concentration falls within a range of 1 to 90 mass %. More preferably, the addition amount is set so that the value of the metal concentration falls within a range of 1 to 65 mass %. Under a condition that the metal concentration exceeds 90 mass %, the amount of the protective agent is small relative to the metal compound, and therefore a stoichiometrical amount of the protective agent required for reducing and adsorbing the metal compound cannot be secured, and there is a possibility that coarse metal particles are generated. Meanwhile, in a case of less than 1 mass %, there is an excessive amount of the protective agent relative to the metal compound, and a production amount of the metal microparticles per unit time is not different from the production amount produced by a conventional homogeneous metal ion solution, thus increasing the production cost.

Further, the amine compound and the calboxylic acid compound are preferably used as the protective agent. By adding the amine compound and the calboxylic acid compound into the liquid phase, the metal microparticles with surfaces coated with the amine compound and the calboxylic acid compound can be obtained.

The reducing agent functions to reduce the metal ions generated from the metal compound, to thereby generate the metal nucleus. According to this embodiment, the metal compound is dispersed and reduced into the liquid phase in a solid state, and therefore a compound not containing alkali metal, halogen, sulfur, phosphorus and showing reducibility to the metal compound, can be suitably used. Note that when the amine compound is used as the protective agent, there is no necessity for using the reducing agent, because the amine compound functions as the reducing agent.

The reducing agent can be selected from a group such as alcohols, aldehydes, amines, calboxylic acids, monosaccharide, and polysaccharide, and can also be used by combining two types or more of these solvents. The reducing agent such as hydrogen peroxide, borane, diborane, hydrazine, citric acid, oxalic acid, and ascorbic acid is suitably dissolved into other solvent, to thereby obtain a reductive solvent. An aliphatic amine compound or a primary alcohol compound is preferable as the reducing agent that can be used suitably in the present invention.

As described above, the aliphatic amine compound acts as the protective agent, and therefore the aliphatic amine compound being the protective agent can be used as the reducing agent.

Ethanol can be more suitably used as the primary alcohol compound. This is because ethanol is less toxic and easy to be handled. Further, ethanol is changed into acetic acid in a process of reducing the metal compound. The acetic acid has the calboxylic group (—COOH), and adsorbs on the metal microparticles and functions as the protective agent by the action of the non-covalent electron pair of the oxygen atom. Namely, similarly to the aforementioned amine compound, ethanol can function as both the reducing agent and the protective agent. In producing the metal microparticles, although the reducing agent and the protective agent are required to be added separately, only a small amount of ethanol may be added because ethanol functions both the reducing agent and the protective agent. Therefore, the metal microparticles can be produced in a high metal concentration, by suppressing an increase of an amount of the liquid phase (reaction solution). As a result, the metal microparticles can be further inexpensively produced.

As the addition amount of the reducing agent, preferably more reducing agent is added than a required stoichiometric amount, although which is not an excessive amount. In a case of not more than the stoichiometric amount of the addition amount, there is a possibility that a reductive reaction time is prolonged, and the reducing agent becomes insufficient and the metal compound is not reduced in a reaction system in which a side reaction occurs in addition to the reduction of the metal compound. On the other hand, in a case of the excessive amount, concentrations of the metal compound and the protective agent are relatively reduced. When the concentration of the metal compound (metal concentration) is reduced to an amount which is not different from the concentration by the conventional homogeneous ion solution method, the production cost of the metal microparticles is increased. Further, when the concentration of the protective agent is reduced to an amount lower than a certain amount, the metal microparticles cannot be sufficiently coated, and there is a possibility that a minute metal microparticles cannot be obtained.

In addition, in preparing the liquid phase, a solvent not showing reducibility such as toluene and xylene, may be mixed as straight-chain hydrocarbon and cyclic hydrocarbon, for the purpose of adjusting a reductive reaction speed of the metal compound and adjusting the affinity between the reducing agent and the protective agent.

Next, the metal compound is added into the prepared liquid phase, to obtain a heterogeneous solid-liquid state in which the metal compound (solid body) and the liquid phase coexist.

According to this embodiment, the metal compound is dispersed in a solid state without dissolving into the liquid phase, and therefore there is no necessity for using the metal compound including alkali metal, halogen, sulfur, and phosphorus being impurities. Metal oxide and noble metal oxide are preferably used as the metal compound not containing impurities. These metal compounds contain only metal and oxygen as constituent elements, and therefore is less toxic, generating only oxygen or a derivative containing oxygen after reaction, and therefore can be suitably used.

The metal compound can be selected for example, from a group consisting of silver actate, silver oxide, silver carbonate, oleic acid silver, silver neodecanoate, bis(acetylacetonato)copper, copper benzoate, copper oxide(I), copper oxide(II), copper acetic acid, copper hydroxide, copper carbonate, gold oxide, platinum oxide, bis(acetylacetonato)platinum, palladium oxide, bis(acetylacetonato)palladium(II), rhodium oxide, tris(acetylacetonato)rhodium(III), rhodium(II) octanoate, rhodium acetic acid(II), acetylacetonato(η4-1,5-cyclo octagon) rhodium(I), iridium oxide, tris(acetylacetonato)iridium(III), ruthenium oxide, iron oxide, iron acetic acid, iron oxalate, iron hydroxide, cobalt oxide, cobalt carbonate, cobalt acetic acid, nickel oxide, nicke carbonate, nickel acetic acid, nickel formic acid, and nickel hydroxide, and two types or more of them can be combined and used. When two types or more metal compounds are used, an alloy fine particle can be obtained by a combination of metal types. Although impurities are not contained in these metal compounds as the composition, when the metal compound is synthesized from the raw material containing impurities, extremely small amount of impurities are probably contained in the metal compound. However, since the contained amount of the impurities is extremely small, the impurities can be removed until the content of the impurities is less than 0.1 mass % by the purifying step as will be described later.

The addition amount of the metal compound is preferably set so that the value of the metal concentration falls within a range of 1 to 90 mass % in the aforementioned formula of the metal concentration. This is because the metal concentration is less than 90 mass % in many cases, when the mass of the metal compound contained in the metal compound is calculated, and when such a metal compound is used, synthesis with the metal concentration exceeding 90 mass % is theoretically impossible. Further, in order to synthesize the metal microparticles, the reducing agent and the protective agent are required, and when the amount of the reducing agent required for reducing the metal compound and the amount of the protective agent for protecting the surfaces of the metal microparticles is calculated, an upper limit of the metal concentration is 90 mass %, and under a condition that the upper limit of the metal concentration exceeds 90 mass %, the metal compound is not reduced and remained as a result, or coarse metal particles are generated as a result. On the other hand, in a case of less than 1 mass %, the production amount of the metal microparticles per unit time is not different from the concentration by the conventional liquid phase method, and therefore there is a possibility that the cost of the metal microparticles is increased. Although depending on the combination of the used metal compound, the reducing agent, and the protective agent, the metal concentration is preferably set in a range of 1 to 65 mass % to obtain the minute metal microparticles with high yield.

Next, the heterogeneous soli-liquid system is heated, then the metal nucleus is precipitated by reduction from the metal compound dispersed into the liquid phase, and the metal nucleus is agglutinated and coated with the protective agent, to thereby form the metal microparticles. More specifically, in the heterogeneous solid liquid system, the reducing agent such as amine compound acts by heating, to thereby cause the reductive reaction. By this reductive reaction, the chemical bond of the metal atom in the metal compound is cut, and the metal ions are generated. The generated metal ions are respectively reduced to become the metal nucleus. In this embodiment, not the homogeneous metal ion solution by dissolving the metal compound into the liquid phase as conventional, but the metal nucleus is generated directly from the metal compound by reducing a solid metal compound in the liquid phase. The generated metal nucleus is agglutinated and grown into the metal microparticles. Meanwhile, the protective agent in the liquid phase is adsorbed on the surfaces of the grown metal microparticles to suppress the growth of the metal microparticles and control the particle size of the fine particle. Then, the surfaces of the generated metal microparticles are coated with the protective agent such as amine compound, in a stable state with no agglutination or fusion allowed to occur.

In the aforementioned generating step, the impurities contained in the metal microparticles, are generated. As the impurities, (1) impurity derived from the raw material, (2) remained raw materials (such as metal compound, reducing agent, and protective agent), and (3) a reactant of acid and base caused by the protective agent, can be considered. The impurity of (1) includes an extremely small amount of halogen, sulfur, and phosphorus contained in the metal compound. The impurity of (2) is an unreacted raw material, which is an organic matter composed of elements such as carbon, hydrogen, oxygen, and nitrogen. The impurity of (3) is salt or an amide compound generated when using both the amine compound and the calboxylic acid compound as the protective agent. A major part of the impurities generated in the generating step are the impurities of (2) and (3).

It can be considered that the impurities of (1) to (3) are contained in the metal microparticles generated in the liquid phase and are adhered to the surfaces of the metal microparticles, or captured by the metal microparticles by the protective agent coating the metal microparticles. The impurities are not limited to one type, and two types or mote substances are contained in the impurities in many cases, and the impurities in a mixture state of a hydrophilic impurity and a lipophilic impurity, are generated in some cases.

Although a heat source used for generating the metal microparticles is not particularly limited, an ultrasonic wave and an electromagnetic wave (such as an ultraviolet lamp, laser, and microwave) can be suitably used, other than external heating by a heater.

In a case of a heating method utilizing a heat conduction such as a heater, the metal compound (solid body) and the liquid phase (reducing agent and protective agent) are uniformly heated at a certain constant temperature, and at a certain moment, the metal compound is reduced and the metal nucleus is generated. The generated metal nucleus moves around by a mobility determined by a temperature of the liquid phase, and collides with a circumferential metal nucleus to grow. Simultaneously, an adsorption reaction of the protective agent occurs on the surface of the metal nucleus, and therefore the metal nucleus is stabilized as the metal microparticles when it has a certain size.

In a case of the electromagnetic wave, when the electromagnetic wave is applied to the heterogeneous solid liquid system in which the metal compound and the liquid phase coexist, the solid body and the liquid phase have different responsiveness. More specifically, an instantaneous temperature gradient is generated between the metal compound and the liquid phase, due to a difference of energy absorption. When a surface temperature of the metal compound becomes larger than a liquid phase temperature, the metal nucleus hardly moves because the liquid phase temperature is low even if the metal nucleus is generated from the surface of the metal compound, thus reducing a collision frequency of the metal nucleuses. As a result, the growth of the metal nucleus is not advanced, and the minute metal microparticles can be obtained.

In a case of the ultrasonic wave, when the heterogeneous solid-liquid system is irradiated with the ultrasonic wave, minute air bubbles called cavitation are generated, and the cavitation repeats quasi-adiabatic expansion and compression, and is crushed finally. In this process, the cavitation itself is in a high temperature/high pressure state, and further a shock wave and a jet stream are also generated at the time of the crush. When the metal compound exists in the solution, the reductive reaction of the metal compound occurs by the following mechanism, using a contact interface between the cavitation containing components of the reducing agent and the metal compound, as a reaction field. First, when the cavitation and the metal compound are brought into contact with each other, the metal compound is reduced by high temperature of the cavitation containing gas of the reducing agent, to thereby generate the metal nucleus. The time from generation to disappearance of the cavitation is 10⁻⁶ seconds order and is extremely short. Therefore, the metal nucleus is rapidly cooled from a high temperature to a solution temperature. Namely, a state of a surface temperature of the metal compound >liquid phase temperature, is realized in an extremely short period of time. Therefore, the mobility of the metal nucleus is low, thus reducing the collision frequency of the metal nucleuses. As a result, the growth of the metal nucleus is not advanced, and therefore the minute metal microparticles can be obtained.

A heating temperature in the generating step of the metal microparticles can be suitably selected depending on the addition amount and the type of the metal compound, the reducing agent, and the protective agent. As one standard of an experiment, preferably the temperature does not exceed a decomposition temperature of the metal compound, and does not exceed a boiling point of a liquid phase component (reducing agent and protective agent). In a case of the temperature exceeding the decomposition temperature of the metal compound, the decomposition/reduction of the metal compound occurs radically, thus posing a problem that the metal microparticles become coarse. In a case of the temperature exceeding the boiling point of the liquid phase component, there is a problem that the reductive reaction hardly occurs due to evaporation of the liquid phase component, and a problem that the protective agent protecting the surfaces of the metal microparticles is insufficient.

Further, a synthetic time in the generating step of the metal microparticles may be set to a time when the reduction of the metal compound is completed. There is a risk of coarsening the metal microparticles by excessively prolonging the synthetic time, and this is not preferable. Further, an atmosphere during production of the metal microparticles can be suitably selected according to the type of the produced metal microparticles. When fine particles of noble metal (Ag, Au, Pt, Pd, Rh, Ru, and Ir, etc.) are produced, production in the air atmosphere is enabled, because the noble metal itself is not oxidized. However, when the metal microparticless other than the noble metal are produced, production in an inert atmosphere or in a reductive atmosphere is preferable to prevent oxidation of the metal microparticless.

Next, the step of purifying the metal microparticles is performed. In the purifying step, the metal microparticles with surfaces coated with the protective agent, is purified using a mixed solvent of water and organic solvent, to thereby remove the impurities contained in the metal microparticles. As described above, three impurities can be considered as follows: (1) impurity derived from the raw material, (2) excess raw material, and (3) reactant of acid and basic by the protective agent. The three impurities are hydrophilic or lipophilic, and are dissolved into water or the organic solvent. Further, even in a case of a mixture of three impurities, the mixture is dissolved into mixed solvent of water and organic solvent. Namely, the impurities showing solubility in water and the organic solvent, is removed by purifying the metal microparticles by the mixed solvent of water and the organic solvent.

More specifically, although the impurity of (1) contains alkali metal derived from the metal compound, halogen, sulfur, and phosphorus in some cases, the impurity is removed by the mixed solvent, thus reducing the content of the impurity. The impurities of (2) and (3) are organic matters compose of elements such as carbon, hydrogen, oxygen, and nitrogen, and therefore can be sufficiently removed by the mixed solvent. Particularly, the impurity of (3) is the salt or the amide compound generated in a case of selecting the amine compound and the calboxylic acid compound, and therefore has high solubility into water, and can be suitably removed. Accordingly, the impurity containing halogen, etc., the hydrophilic impurity, and the lipophilic impurity can be removed respectively by purification using the mixed solvent. Note that an unreacted metal compound can be considered as the impurity not dissolved into the mixed solvent. However, such a type of impurity can be easily separated utilizing a difference in particle size between the metal compound and the metal microparticles.

In the purifying step, purification is preferably performed in the mixed solvent of water and organic solvent in which the carbon number is 6 or less. By using the organic solvent with the carbon number being 6 or less, the water and the mixed solvent can be suitably mixed.

In the method for producing the metal microparticles according to this embodiment, the metal compound is not dissolved into the liquid phase, and the metal nucleus is generated from the metal compound dispersed in a solid state, to thereby produce the metal microparticles. Further, the generated metal microparticles are purified by the mixed solvent of water and organic solvent, to thereby remove the impurities of alkali metal, halogen, sulfur, or phosphorus contained in the metal microparticles during production.

According to the production method of this embodiment, the metal compound is not dissolved, and therefore there is no necessity for using a particular metal compound and a particular reducing agent containing a large quantity of impurities such as alkali metal, halogen, sulfur, or phosphorus. Namely, a mixed amount of the impurity such as halogen derived from the raw material can be reduced.

In addition, by performing purification using the mixed solvent of water and organic solvent, the impurity contained in the metal microparticles can be reduced, and the amount of the impurity can be less than 0.1 mass % relative to the mass of the metal microparticles. Further, even in a case of a combination of the protective agents generating salt or amide compound, the salt can be suitably removed, and therefore the combination of the protective agents is not excessively limited.

Moreover, since the metal nucleus is generated from the metal compound in the liquid phase, the metal concentration during production can be set to be extremely high, thus increasing the production amount per unit time, so that the metal microparticles are generated at a low cost.

### (Metal Microparticles)

Subsequently, the metal microparticles according to an embodiment of the present invention will be described.

The metal microparticles of this embodiment is produced by the aforementioned method for producing the metal microparticles, wherein the surfaces are coated with at least one type of the amine compound and the calboxylic acid compound as the protective agent, and a total content of the alkali metal, halogen, sulfur, and phosphorus contained in the metal microparticles is less than 0.1 mass % relative to the mass of the metal microparticles. According to this structure, the total content of the impurities such as alkali metal, halogen, sulfur, and phosphorus contained in the metal microparticles are small, and therefore the metal microparticles are easily sintered during sintering.

In the aforementioned metal microparticles, the surface is preferably coated with the amine compound and the calboxylic acid compound as the protective agent. The reason is as follows. The protective agent such as calboxylic compound and amine compound is required to coat and stabilize the metal microparticles in a minute state. In addition, the protective agent is required to be speedily desorbed from the surfaces of the metal microparticles at a low sintering temperature during sintering of the metal microparticles. The protective agent stable at a high temperature is likely to be remained on the surfaces of the metal microparticles during sintering, resulting in being remained on the formed metal coat. As a result, the property of the formed metal coat, such as conductivity, is deteriorated. In this point, in a case of the metal microparticles coated with the amine compound and the calboxylic acid compound as the protective agent, an amide forming reaction occurs during sintering between the calboxylic acid compound and the amine compound, thus promoting the desorption of two protective agents. Further, since the desorption of the protective agents is promoted, the sintering temperature can be reduced.

Preferably, each metal microparticle has an average particle size of 1 nm or more and 1000 nm or less, and particularly 1 nm or more and 100 nm or less. The metal microparticles with this size can be sintered at a low temperature by a melting point lowering phenomenon. As the metal microparticles, gold, silver, copper, platinum, or palladium is preferable.

### (Metal Paste)

An embodiment of the metal paste containing the aforementioned metal microparticles will be described. The metal paste of this embodiment contains the metal microparticles and a solvent composition, and can be utilized as the metal paste with low temperature sintering property.

The content of the metal microparticles is preferably set in a range of 5 mass % or more and 90 mass % or less relative to the total mass of the metal paste. When the content of the metal microparticles is less than 5 mass %, it is difficult to obtain a smooth metal coat with less cracks and vacancies when the metal paste is sintered. Meanwhile, when the content of the metal microparticles exceeds 90 mass %, viscosity of the metal paste becomes extremely high, thus causing hindering in coating property. Further, volumetric shrinkage occurs in the metal paste during sintering when the solvent composition and the protective agent are removed. Therefore, the content of the metal microparticles is further preferably set in a range of 30 mass % or more and 80 mass % or less in consideration of the volumetric shrinkage. By setting this numerical range, the smooth metal coat can be obtained. Note that the content of the metal paste can be suitably prepared according to a target thickness of the metal coat and the viscosity of the paste.

The solvent composition is used for preparing the viscosity suitable for coating the metal paste. The solvent composition having affinity with the protective agent for coating the metal microparticles, not easily evaporated at a room temperature, and being a low-polar solvent or a nonpolar solvent having a relatively high boiling point, is preferable. For example, the solvent composition can be selected from a group consisting of water, alcohols, aldehydes, ethers, esters, amines, monosaccharide, polysaccharide, straight chain hydrocarbons, fatty acids, and aromatics, and a plurality of solvents may be combined and used. More specifically, normal hydrocarbon with carbon number of 8 to 16, toluene, xylene, 1-decanol, and terpineol can be suitably used. Note that wax or resin can be slightly added into the solvent composition as additive agents, for the purpose of preparing moldability and viscosity of the metal paste. Further, in order to speedily desorb the protective agent during sintering, a desorbing agent may be added to the protective agent.

According to the metal paste of this embodiment, the impurities are less contained in the metal microparticles, and sintering property is excellent.

### (Metal Coat)

The aforementioned metal paste is sintered and the protective agent is desorbed, and the metal microparticles are fused, to thereby obtain the metal coat. The metal microparticles have less amounts of impurities and has an excellent sintering property, and therefore the metal coat made of the metal paste has less amount of residual impurities, having a small volume resistivity, and has an excellent conductivity.

### EXAMPLES

The metal microparticles of examples according to the present invention were produced by a method and a condition described below. These examples are given as examples of the metal microparticles of the present invention, and the present invention is not limited to these examples.

### Example 1

In example 1, the metal microparticles with surfaces coated with the amine compound and the calboxylic acid compound as the protective agent, were produced.

5.0 g of Au₂O₂.1.5H₂O being the metal compound (formula weight: 468.8 g/mol, contained Au weight: 4.23 g), 10.8 g of triethylamine being the reducing agent and the protective agent (molecular weight: 101.1 g/mol, amount of substance: 0.11 mol), 4.95 g of bis(2-ethylhexyl) amine being the protective agent (molecular weight: 241.46 g/mol, amount of substance: 0.021 mol), and 0.645 g of acetic acid being the protective agent (molecular weight: 60.05 g/mol, amount of substance: 0.011 mol) were mixed, which were then added into an 100 ml eggplant-shaped flask. The concentration of the Au metal contained in this solution was about 19.8 mass %. The solution was heated at 75° C. for 1.5 hours while being stirred, to reduce Au₂O₃.1.5H₂O and obtain a dispersion liquid of Au metal microparticles. 100 g of n-hexane was added to this dispersion liquid, to thereby remove unreacted Au₂O₃.1.5H₂O particle and coarse Au metal microparticles by filtering using a filter paper of 1 μm. 100 g of water and 500 g of methanol were added to a recovered filtrate, to thereby remove excessive triethyl amine, bis(2-ethylhexyl)amine, and acetic acid, etc., on the surfaces of the Au metal microparticles, so that the Au metal microparticles were precipitated. A supernatant liquid was removed, and the Au metal microparticles powder was recovered and dried at 40° C. for 1 hour, to thereby obtain the metal microparticles of example 1. Producing conditions of the metal microparticles of example 1 are shown in table 1.

TABLE 1

| | Metal compound | | | | | | |
|---|---|---|---|---|---|---|---|
| | | Metal | | | | | |
| | | concentration | Reducing agent or protective agent | | | | |
| | Type | [mass %] | 1 | 2 | 3 | Purified liquid | |
| Example 1 | Au oxide | 19.8 | Triethylamine | Bis(2-ethylhexyl) | Acetic acid | Water | Methanol |
| | | | | amine | | | |
| Example 2 | Ag oxide | 29.9 | Dipropylamine | Dodecylamine | — | Water | Methanol |
| Example 3 | Pt oxide | 30.2 | Ethanol | Dodecylamine | — | Water | Methanol |
| Example 4 | Pd oxide | 6.28 | Bis(2-ethylhexyl) | Dodecylamine | — | Water | Methanol |
| | | | amine | | | | |
| Example 5 | Cu oxide | 3.84 | Bis(2-ethylhexyl) | Dodecylamine | — | Water | Methanol |
| | | | amine | | | | |
| Example 6 | Au oxide | 25.6 | Ethanol | Acetic acid | — | Water | Methanol |
| Example 7 | Au oxide | 19.8 | Triethylamine | Bis(2-ethylhexyl) | Acetic acid | Water | Methanol |
| | | | | amine | | | |
| Com. ex. 1 | Au oxide | 19.8 | Triethylamine | Bis(2-ethylhexyl) | Acetic acid | — | Methanol |
| | | | | amine | | | |
| Com. ex. 2 | Au oxide | 19.8 | Triethylamine | Bis(2-ethylhexyl) | Acetic acid | Water | — |
| | | | | amine | | | |
| Com. ex. 3 | Au oxide | 36.9 | Hydrogen peroxide | — | — | Water | Methanol |
| Com. ex. 4 | Au oxide | 36.9 | Acetic acid | — | — | — | — |
| Com. ex. 5 | Au metal complex | 2.55 | Hexadecylamine | — | — | Water | Methanol |

Com. ex. = Comparative example

Physical properties of the metal microparticles obtained in example 1 were evaluated by a measurement method described below.

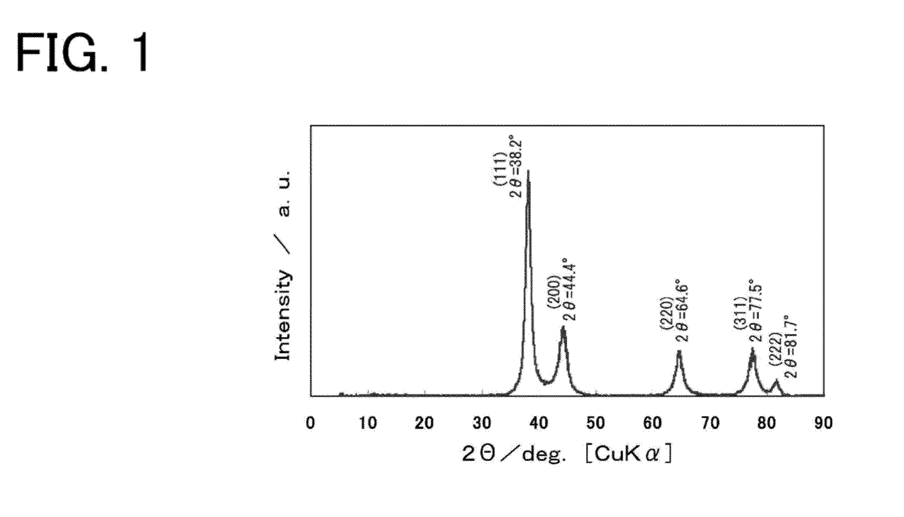

Qualitative analysis of the metal microparticles was performed by XRD measurement. The XRD measurement of the Au metal microparticles powder was performed using X-Ray Diffractometer “RINT2000” (by Rigaku Corp.), to thereby identify a phase of the metal microparticles. As a result, it was confirmed that the Au metal microparticles were made of Au metal having a face-centered cubic (fcc). In FIG. 1, a peak of 2θ=38.2° corresponds to (111) plane, a peak of 44.4° corresponds to (200) plane, a peak of 64.6° corresponds to (220) plane, a peak of 77.5° corresponds to (311) plane, and a peak of 81.7° corresponds to (222) plane.

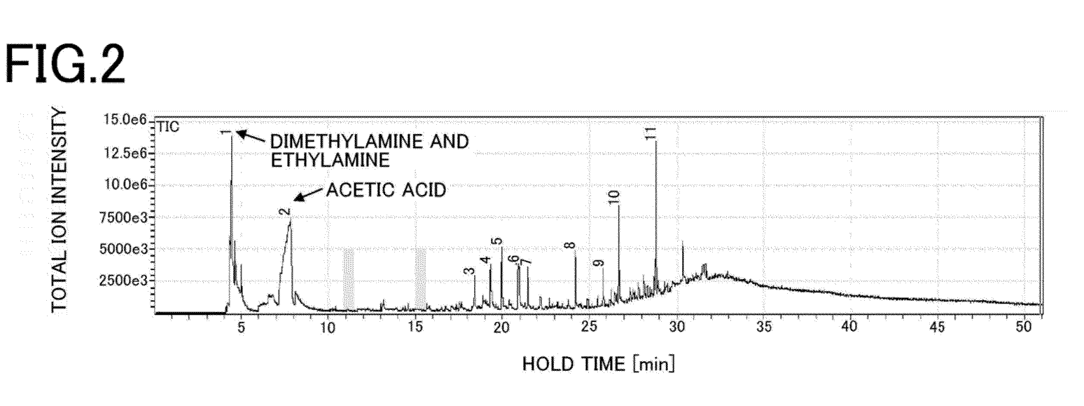

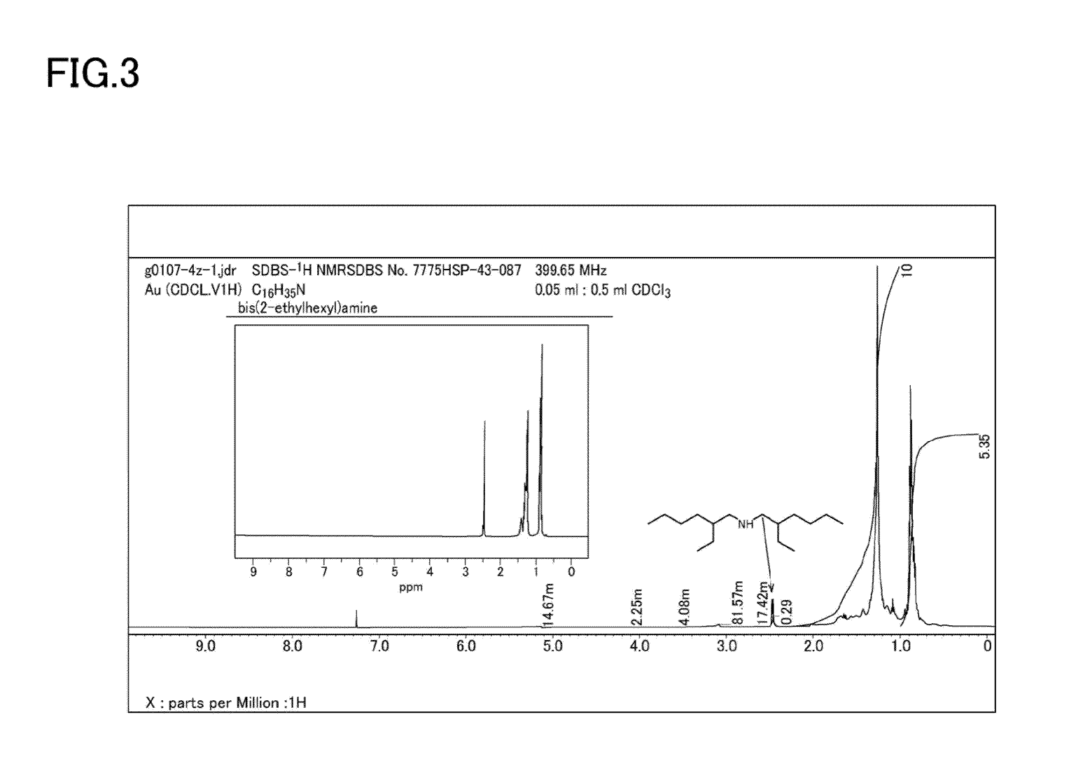

An analysis of the surfaces of the Au metal microparticles was performed as an identification of the protective agent component. In the identification of the protective agent component, IR measurement (FTIR-615 by JASCO), GC-MS measurement (GC-17A/PQ5050A by Shimadzu Corporation), and NMR measurement (ECA-500 by JEOL Ltd.) were performed. When the IR measurement was performed, the peak belonging to the amine group was confirmed in the vicinity of 3400 cm⁻¹ and 1650 nm¹. Further, when the GC-MS measurement was performed, as shown in FIG. 2, dimethylamine, ethylamine, and acetic acid were detected as components of the protective agent. Note that the dimethylamine and the ethylamine were derivatives from triethylamine of the protective agent. Moreover, as a result of the NMR measurement, as shown in FIG. 3, the peak derived from the bis(2-ethylhexyl)amine of the protective agent was detected. As described above, it was confirmed that the surfaces of the Au metal microparticles of example 1 were coated with triethylamine, bis(2-ethylhexyl)amine, and acetic acid.

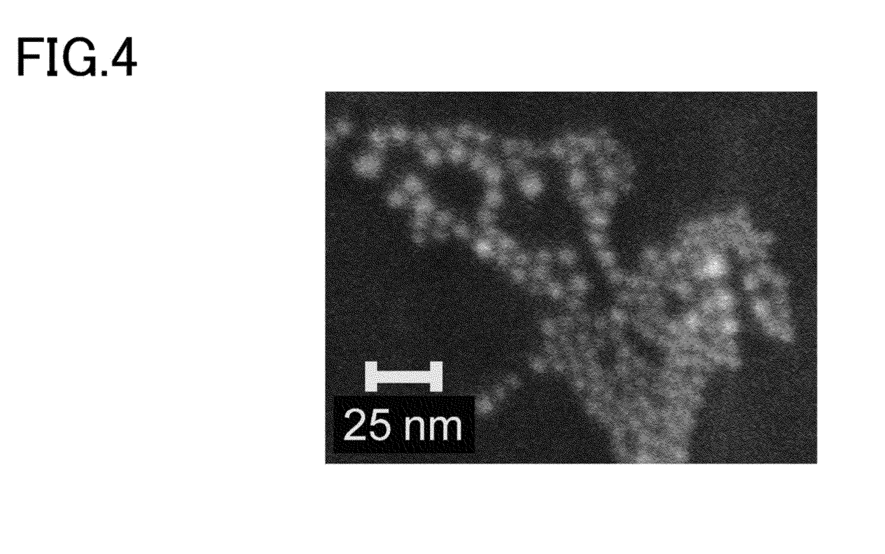

The metal microparticles were observed using FE-SEM (S-5000 by HITACHI Corporation). When the Au metal microparticless of example 1 were dispersed again in n-hexanee solvent of example 1, a red color solution was obtained. This solution was dropped on a microgrid (STEM150Cu grid by Okenshoji Corporation), and dried at a room temperature. Then, when observed by FE-SEM, the Au metal microparticles with a particle size of 8 to 12 nm were confirmed as shown in FIG. 4.

The impurity elements contained in the metal microparticles and the content thereof were quantitatively evaluated by ICP Optical Emission Spectrometry (OPTIMA-3300XL by PerkinElmer). The Au metal microparticles obtained in example 1 were dispersed in n-hexane so that the content thereof was 40 mass %, and the solution component was analyzed. From this result, it was found that 0.025 mass % of Cl and 0.02 mass % of Na were contained in the Au metal microparticles powder. Further, halogen excluding Cl, alkali metal excluding Na, sulfur, and phosphorus were not detected. In this example, a small amount of impurities was detected, although the raw material not containing the alkali metal, halogen, sulfur, or phosphorus is used as the composition. This is because the gold oxide used as the metal compound was synthesized from the gold chloride, and an extremely small amount of halogen was detected. Similarly, it can be considered that the detected Na is also derived from the raw material. However, the content of the impurities contained in the metal microparticles was set to less than 0.1 mass % by purification using the mixed solvent.

Subsequently, 2.0 g of Au metal microparticles powder (average particle size: about 9 nm) fabricated in example 1, 3.2 g of pentadecane being the solvent, 3.4 g of n-hexane, 0.6 g of dodecylamine, and 0.41 g of nonenyl succinic anhydride, being eluents were mixed, to thereby prepare Au paste by removing the n-hexane solvent by vacuum distillation (20° C., 4 mmHg). The viscosity of the prepared Au paste was about 10 mPa·s, and Au content was 32 mass %.

The Au metal coat was produced using the prepared Au paste. A glass substrate was spin-coated with the Au paste, which was then sintered at a temperature of 250° C. for 60 minutes, to thereby produce the Au metal coat. The volume resistivity of the Au metal coat was measured using four-probe electric resistance measurement device. The obtained volume resistivity of the Au metal coat was about 5.2 μΩcm.

The Au metal microparticles have less content of impurities and have an excellent sintering property. The metal coat formed from the metal microparticles has less content of impurities, has small volume resistivity, and has excellent conductivity. Further, owing to the coating with the amine compound and the calboxylic acid compound as the protective agent, the amide forming reaction occurs during sintering, thus achieving the sintering at a low temperature.

Note that both the amine compound and the calboxylic acid compound are used as the protective agent in example 1, and therefore it can be considered that the salt or the amide compound are generated when producing the metal microparticles, which are then contained in the metal microparticles. However, if a low volume resistivity of the formed metal coat is taken into consideration, it is found that the salt or the amide compound generated during production of the metal microparticles, is removed by purifying the mixed solvent, and the content thereof is reduced. Measurement results are shown in table 2.

TABLE 2

| | Metal fine particle | | | | | | | | Metal paste | | Metal film |
|---|---|---|---|---|---|---|---|---|---|---|---|
| | Metal | Particle | Average particle | Impurity amounts[mass %] | | | | | Viscosity | Metal contents | Volume resistivity |
| | types | size[nm] | size[nm] | Cl | Na | S | P | Total | [mPa · s] | [mass %] | [μΩ · cm] |
| Example 1 | Au | 8~12 | 9 | 0.025 | 0.02 | 0 | 0 | 0.045 | 10 | 32 | 5.2 |
| Example 2 | Ag | 10~15 | 12 | 0 | 0.025 | 0 | 0 | 0.025 | 10 | 32 | 2.9 |
| Example 3 | Pt | 2~10 | 5 | 0.005 | 0 | 0 | 0 | 0.005 | 10 | 32 | 10.5 |
| Example 4 | Pd | 8~30 | 18 | 0.0275 | 0.025 | 0 | 0 | 0.053 | 10 | 32 | 11.5 |
| Example 5 | Cu | 50~150 | 100 | 0.005 | 0 | 0 | 0 | 0.005 | 10 | 32 | 8.0 |
| Example 6 | Au | 8~15 | 11 | 0.025 | 0.02 | 0 | 0 | 0.045 | 10 | 32 | 6.0 |
| Example 7 | Au | 8~12 | 9 | 0.025 | 0.02 | 0 | 0 | 0.045 | 10 | 32 | 5.3 |
| Com. ex. 1 | Au | 8~12 | 9 | 0.075 | 0.06 | 0 | 0 | 0.135 | 10 | 32 | 20.8 |
| Com. ex. 2 | Au | 8~12 | 9 | 0.115 | 0.095 | 0 | 0 | 0.21 | 10 | 32 | 24 |
| Com. ex. 3 | Au | Several mm | — | 0.025 | 0.02 | 0 | 0 | 0.045 | — | | Unmeasurable |
| Com. ex. 4 | Au | Metal fine particle cannot be formed | | | | | | | — | | Unmeasurable |
| Com. ex. 5 | Au | 5~20 | 10 | 1.25 | 0 | 3 | 0 | 4.25 | 10 | 32 | 29 |

Com. ex. = Comparative example

### Example 2

The metal microparticles with surfaces coated with the amine compound as the protective agent, were produced in example 2.

5.0 g of Ag₂O being the metal compound (formula weight: 231.72 g/mol, contained Ag weight: 4.65 g), 6.55 g of dipropylamine being the reducing agent and the protective agent (molecular amount: 101.1 g/mol, amount of substance: 0.0648 mol), and 3.98 g of dodecylamine being the protective agent (molecular weight: 185.35 g/mol, amount of substance: 0.0215 mol) were mixed and added into the 100 ml eggplant shaped flask. The concentration of the Ag metal contained in this solution was about 29.9 mass %. The mixed solution was heated at 90° C. for 1 hour while being stirred, to reduce Ag₂O and obtain the dispersion liquid of Ag metal microparticles. 100 g of n-hexanee was added to this dispersion liquid, to thereby remove unreacted Au₂O₃.1.5H₂O particle and coarse Au metal microparticles by filtering using a filter paper of 1 μm. 100 g of water and 500 g of methanol were added to a recovered filtrate, to thereby remove excessive dodecylamine and dipropylamine on the surfaces of the Ag metal microparticles, so that the Ag metal microparticless were precipitated. A supernatant liquid was removed, and the Ag metal microparticles powder was recovered and dried at 40° C. for 1 hour, to thereby obtain the Ag metal microparticles of example 2.

The Ag metal microparticles obtained in example 2 were measured and evaluated similarly to example 1.

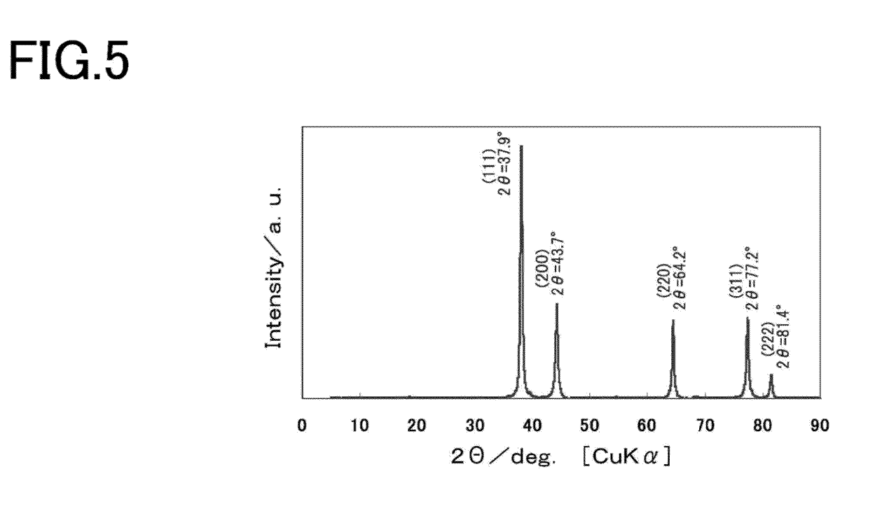

As a result of performing the XRD measurement of the Ag metal microparticles powder was performed, it was confirmed that Ag metal had a face-centered cubic (fcc). In FIG. 5, the peak of 2θ=37.9° corresponds to (111) plane, the peak of 43.7° corresponds to (200) plane, the peak of 64.2° corresponds to (220) plane, the peak of 77.2° corresponds to (311) plane, and the peak of 81.4° corresponds to (222) plane.

Analysis of the protective agent component coating the surface of the Ag metal microparticles was performed. When the IR measurement was performed, the peak belonging to the amine group was confirmed in the vicinity of 3400 cm⁻¹ and 1650 nm⁻¹. Further, when the GC-MS measurement was performed, dipropylamine and dodecylamine were detected. From this result, it was confirmed that the produced Ag metal microparticles were coated with dipropylamine and dodecylamine.

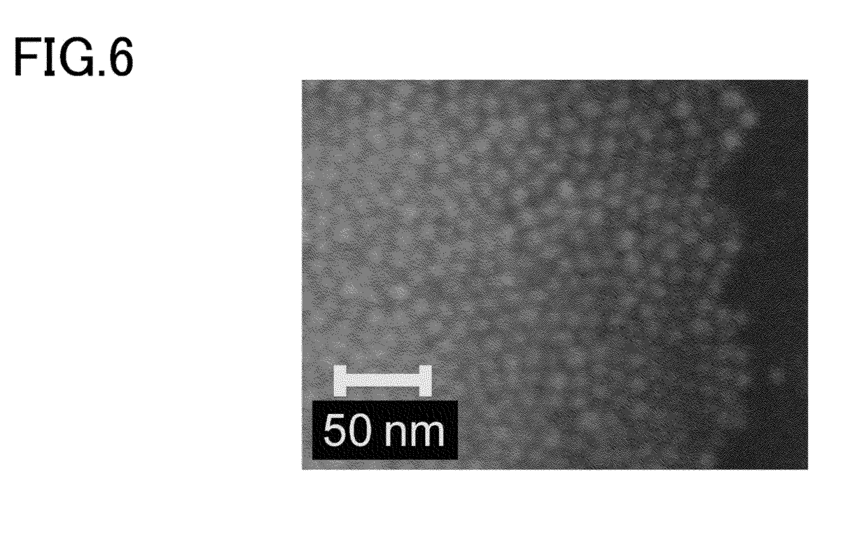

When the Ag metal microparticles powder was dispersed again in n-hexanee solvent, a yellow color solution was obtained. This solution was dropped on a microgrid, and dried at a room temperature. Then, when observed by FE-SEM, the Ag metal microparticles with a particle size of 10 to 15 nm were confirmed as shown in FIG. 6.

When the impurity element contained in the Ag metal microparticles and the content thereof were measured, 0.025 mass % of Na component was contained in the Ag metal microparticles powder, and halogen, alkali metal excluding Na, sulfur, and phosphorus were not detected.

Subsequently, similarly to example 1, an Ag paste was prepared using the Ag metal microparticles fabricated in example 2. The viscosity of the prepared Ag paste was about 10 mPa·s, and the content of Au was 32 mass %. When an Ag metal coat was produced using the Ag paste, the produced Ag metal coat had a volume resistivity of about 2.9 μΩ·cm. Note that in example 2, only the amine compound was used as the protective agent, and therefore salt, etc., was not generated and not contained in the metal microparticles.

### Examples 3 to 5, comparative example 1 to 5

In examples 3 to 5, as shown in table 1, types of the metal compound and the reducing agent or the protective agent of example 1 or example 2 were changed, to produce the metal microparticles. Further, in comparative examples 1 to 5, the metal compound, the reducing agent, the protective agent, or the purifying conditions were changed to produce the metal microparticles.

### Example 3

5.0 g of PtO₂ being the metal compound (formula weight: 227.08 g/mol, contained Pt weight: 4.28 g), 5.08 g of ethanol being the reducing agent (molecular weight: 46.07 g/mol, amount of substance: 0.11 mol), 4.08 g of dodecylamine being the protective agent (molecular weight: 185.35 g/mol, amount of substance: 0.022 mol) were mixed, which were then added into the 100 ml eggplant-shaped flask. The concentration of the Pt metal contained in this solution was about 30.2 mass %. This solution was heated at 60° for 2 hours while being stirred, to reduce PtO₂, and obtain a dispersion liquid of Pt metal microparticles. This dispersion liquid was purified similarly to the aforementioned example 1, to thereby obtain the Pt metal microparticles of example 3.

The Pt metal microparticles obtained in example 3 were measured and evaluated similarly to example 1.

When the XRD measurement of the Pt metal microparticles powder was performed, it was confirmed that this was the Pt metal having a face-centered cubic (fcc). Then, the protective agent on the surfaces of the Pt metal microparticles was analyzed. When the IR measurement was performed, the peak in the vicinity of 1700 cm⁻¹ belonging to the calboxylic group, and the peak in the vicinity of 3400 cm⁻¹ and 1650 cm⁻¹ belonging to the amine group, were confirmed. Further, when the GC-MS measurement was performed, ethanol, acetic acid (oxide of ethanol), and dodecylamine were detected. As described above, it was confirmed that the produced Pt metal microparticles were coated with ethanol, acetic acid, and dodecylamine.

When the Pt metal microparticles powder was dispersed again in the n-hexanee solvent, a black color solution was obtained. This solution was dropped on the microgrid, and dried at a room temperature. Then, when observed by FE-SEM, the Pt metal microparticles with a particle size of 2 to 10 nm were confirmed.

When the impurity element contained in the Pt metal microparticles and the content thereof were measured, 0.005 mass % of Cl component was contained in the Pt metal microparticles powder, and halogen excluding Cl, alkali metal, sulfur, and phosphorus were not detected.

Subsequently, similarly to example 1, a Pt paste was prepared using the Pt metal microparticles fabricated in example 3. The viscosity of the prepared Pt paste was about 10 mPa·s, and the content of Pt was 32 mass %. When a Pt metal coat was produced using the Pt paste, the produced Pt metal coat had a volume resistivity of about 10.5 μΩ·cm.

### Example 4

5.0 g of Pd(C₅H₇O₂)₂ being bis(acetylacetonato)palladium (formula amount: 304.4 g/mol, contained Pd weight: 1.75 g), 19.8 g of bis(2-ethylhexyl)amine being the reducing agent and the protective agent (molecular weight: 241.46 g/mol, amount of substance: 0.082 mol), and 3.03 g of dodecylamine being the protective agent (molecular amount: 185.35 g/mol, amount of substance: 0.0163 mol) were mixed, which were then added into 100 ml eggplant-shaped flask. The concentration of the Pd metal contained in this solution was about 6.28 mass %. This solution was heated at 200° C. for 3 hours while being stirred, to reduce Pd(C₅H₇O₂)₂ and obtain the dispersion liquid of the Pd metal microparticles. The dispersion liquid was purified similarly to example 1, to thereby obtain the Pd metal microparticles of example 4. This dispersion liquid was purified similarly to example 1, to thereby obtain the Pd metal microparticles of example 4.

The Pd metal microparticles obtained in example 4 were measured and evaluated similarly to example 1.

When the XRD measurement of the Pd metal microparticles powder was performed, it was confirmed that this was the Pd metal having a face-centered cubic (fcc). When the IR measurement was performed as the analysis of protective agent component on the surfaces of the Pd metal microparticles, it was confirmed that the peak belonging to the amine group was in the vicinity of 3400 cm⁻¹ and 1650 cm⁻¹. Further, when the GC-MS measurement was performed, dodecylamine was detected. In addition, as a result of the NMR measurement, the peak derived from the bis(2-ethylhexyl)amine of the protective agent was detected. As described above, it was confirmed that the produced Pd metal microparticles were coated with bis(2-ethylhexyl)amine and dodecylamine.

When the Pd metal microparticles powder was dispersed again in the n-hexanee solvent, a black color solution was obtained. This solution was dropped on the microgrid, and dried at a room temperature. Then, when observed by FE-SEM, the Pd metal microparticles with a particle size of 8 to 30 nm were confirmed.

When the impurity element contained in the Pd metal microparticles and the content thereof were measured, 0.0275 mass % of Cl component was contained in the Pd metal microparticles powder, and 0.025 mass % of Na component was contained in the Pd metal microparticles powder, and halogen excluding Cl, alkali metal, sulfur, and phosphorus were not detected.

Subsequently, similarly to example 1, a Pd paste was prepared using the Pd metal microparticles fabricated in example 4. The viscosity of the prepared Pd paste was about 10 mPa·s, and the content of Pd was 32 mass %. When a Pd metal coat was produced using the Pd paste, the produced Pd metal coat had a volume resistivity of about 11.5 μΩ·cm.

### Example 5

5.0 g of Cu (C₅H₇O₂)₂ being bis(acetylacetonato)copper (formula weight: 261.5 g/mol, contained Cu weight: 1.21 g), 23.1 g of bis(2-ethylhexyl) amine being the protective agent and the reducing agent (molecular weight: 241.46 g/mol, amount of substance: 0.095 mol), and 1.41 g of dodecylamine being the protective agent (molecular amount: 185.35 g/mol, amount of substance: 0.019 mol) were mixed, and added into the 100 ml eggplant shaped flask. The concentration of the metal copper contained in this solution was about 3.84 mass %. The solution was heated at 220° C. for 3 hour while being stirred in a nitrogen atmosphere, to reduce Cu(C₅H₇O₂)₂ and obtain the dispersion liquid of Cu metal microparticless coated with dodecylamine and bis(2-ethylhexyl)amine. This dispersion liquid was purified similarly to the aforementioned example 1, to thereby obtain the Cu metal microparticles of example 5.

The Cu metal microparticles obtained in example 5 were measured and evaluated similarly to example 1.

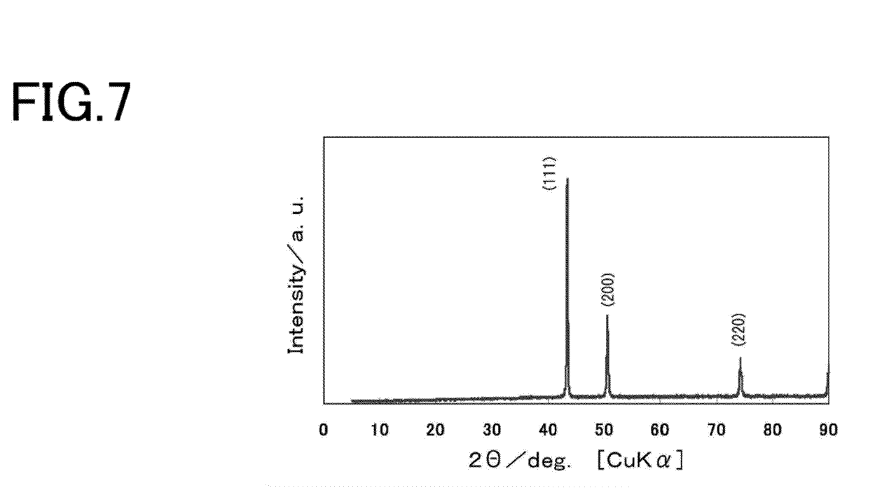

When the XRD measurement of the Cu metal microparticles powder was performed, it was confirmed that this was the Cu metal having the face-centered cubic (fcc) as shown in FIG. 7. When the IR measurement, the GC-MS measurement, and the NMR measurement were performed as the analysis of the protective agent component on the surface of the Cu metal microparticles, it was confirmed that similarly to example 4, the produced Cu metal microparticles were coated with bis(2-ethylhexyl) amine and dodecylamine.

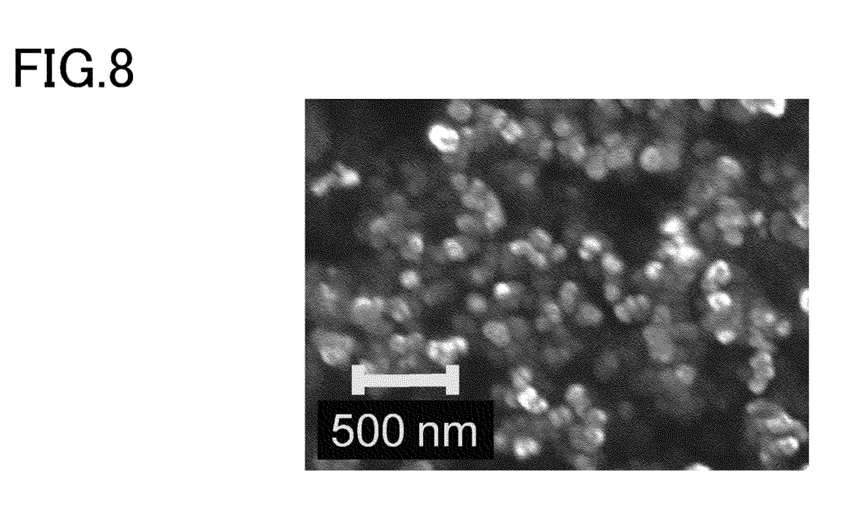

When the Cu metal microparticles powder was dispersed again in the n-hexanee solvent, a green color solution was obtained. This solution was dropped on the microgrid, and dried at a room temperature. Then, when observed by FE-SEM, the Cu metal microparticles with a particle size of 50 to 150 nm were confirmed as shown in FIG. 8.

When the impurity element contained in the Cu metal microparticles and the content thereof were measured, 0.005 mass % of Cl component was contained in the Cu metal microparticles powder, and halogen excluding Cl, alkali metal, sulfur, and phosphorus were not detected.

Subsequently, similarly to example 1, a Cu paste was prepared using the Cu metal microparticles fabricated in example 5. The viscosity of the prepared Cu paste was about 10 mPa·s, and the content of Cu was 32 mass %. When a Cu metal coat was produced using the Cu paste, the produced Cu metal coat had a volume resistivity of about 8.0 μΩ·cm.

### Example 6

In example 6, the metal microparticles with surfaces coated with the calboxylic acid compound being the protective agent, were produced.

5.0 g of Au₂O₃.1.5H₂O being the metal compound (formula amount: 468.8 g/mol, contained Au weight: 4.23 g), 5.08 g of ethanol being the reducing agent (molecular weight: 46.07 g/mol, amount of substance: 0.11 mol), and 6.45 g of acetic acid being the protective agent (molecular amount: 60.05 g/mol, amount of substance: 0.107 mol) were mixed, which were then added into 100 ml eggplant-shaped flask. The concentration of the Au metal contained in this solution was about 25.6 mass %. This solution was heated at 75° C. for 1.5 hours while being stirred, to reduce Au₂O₃.1.5H₂O and obtain the dispersion liquid of the Au metal microparticles. The dispersion liquid was purified similarly to example 1, to thereby obtain the Au metal microparticles of example 6.

The Au metal microparticles obtained in example 6 were measured and evaluated similarly to example 1.

When the XRD measurement of the Au metal microparticles powder was performed, it was confirmed that this was the Au metal having the face-centered cubic (fcc). Then, the protective agent component on the surfaces of the Au metal microparticles was analyzed. When the IR measurement was performed, it was confirmed that the peak belonging to the calboxylic acid group was in the vicinity of 1700 cm⁻¹. Further, when the GC-MS measurement was performed, ethanol and acetic acid (oxide of ethanol) were detected. As described above, it was confirmed that the produced Au metal microparticles were coated with ethanol and acetic acid.

When the Au metal microparticles powder was dispersed again in the n-hexane solvent, a black color solution was obtained. This solution was dropped on the microgrid, and dried at a room temperature. Then, when observed by FE-SEM, the Au metal microparticles with a particle size of 8 to 15 nm were confirmed.

When the impurity element contained in the Au metal microparticles and the content thereof were measured, 0.025 mass % of Cl component was contained in the Au metal microparticles powder, and 0.02 mass % of Na component was contained in the Au metal microparticles powder, and halogen excluding Cl, alkali metal, sulfur, and phosphorus were not detected.

Subsequently, similarly to example 1, an Au paste was prepared using the Au metal microparticles fabricated in example 6. When an Au metal coat was produced using the Au paste, the produced Au metal coat had a volume resistivity of about 6.0 μΩcm. Note that in example 6, only the calboxylic acid compound is used as the protective agent, and therefore salt, etc., is not generated and is not contained in the metal microparticles.

### Example 7

In example 7, the metal microparticles with surfaces coated with the amine compound and the calboxylic acid compound being the protective agent, were produced.

5.0 g of Au₂O₃.1.5H₂O being the metal compound (formula amount: 468.8 g/mol, contained Au weight: 4.23 g), 10.8 g of triethylamine being the reducing agent and the protective agent (molecular weight: 101.1 g/mol, amount of substance: 0.11 mol), 4.95 g of bis(2-ethylhexyl) amine being the protective agent (molecular amount: 241.46 g/mol, amount of substance: 0.021 mol), and 0.645 g of butylic acid being the protective agent (molecular amount: 88.11 g/mol, amount of substance: 0.007 mol) were mixed, and added into 100 ml eggplant-shaped flask. The concentration of the Au metal contained in this solution was about 19.8 mass %. This solution was heated at 75° C. for 1.5 hours while being stirred, to reduce Au₂O₃.1.5H₂O and obtain the dispersion liquid of the Au metal microparticles. The dispersion liquid was purified similarly to example 1, to thereby obtain the Au metal microparticles of example 7.

The Au metal microparticles obtained in example 7 were measured and evaluated similarly to example 1.

When the XRD measurement of the Au metal microparticles powder was performed, it was confirmed that this was the Au metal having the face-centered cubic (fcc). Then, the protective agent component on the surfaces of the Au metal microparticles was analyzed. When the IR measurement was performed, it was confirmed that the peak belonging to the calboxylic acid group was in the vicinity of 1700 cm⁻¹, and the peak belonging to the amine group was in the vicinity of 3400 cm⁻¹ and 1650 cm⁻¹. Further, when the GC-MS measurement was performed, triethylamine, bis(2-ethylhexyl) amine, and butyric acid were detected. As described above, it was confirmed that the produced Au metal microparticles were coated with triethylamine, bis(2-ethylhexyl)amine, and butyric acid.

When the Au metal microparticless were dispersed again in the n-hexane solvent, a black color solution was obtained. This solution was dropped on the microgrid, and dried at a room temperature. Then, when observed by FE-SEM, the Au metal microparticles with a particle size of 8 to 12 nm were confirmed.

When the impurity element contained in the Au metal microparticles and the content thereof were measured, 0.025 mass % of Cl component was contained in the Au metal microparticles powder, and 0.02 mass % of Na component was contained in the Au metal microparticles powder, and halogen excluding Cl, alkali metal excluding Na, sulfur, and phosphorus were not detected.

Subsequently, similarly to example 1, the Au paste was prepared using the Au metal microparticles fabricated in example 7. When an Au metal coat was produced using the Au paste, the produced Au metal coat had a volume resistivity of about 5.3 μΩCm.

### Comparative Example 1

Comparative example 1 is different from example 1 only in a point that purification is performed only by methanol, and the other conditions are the same as those of example 1, to thereby produce the Au metal microparticles.

Similarly to example 1, the Au metal microparticles of comparative example 1 were measured and evaluated. As a result, it was found that in the Au metal microparticles of comparative example 1, the amount of impurities was increased compared with the Au metal microparticles of example 1. No difference was confirmed in the other measurement. As shown in table 2, the Au metal microparticles of comparative example 1 contain 0.075 mass % of Cl, and 0.06 mass % of Na, which are the amounts more increased than those of example 1 (Cl: 0.025 mass %, Na: 0.02 mass %). Note that halogen excluding Cl, alkali metal excluding Na, sulfur, and phosphorus were not detected similarly to example 1.

This result can be considered as follows. Namely, out of the impurities containing Cl and Na, water-insoluble impurities were purified and removed by ethanol only, and water-soluble impurities were not removed but contained in the metal microparticles, thus increasing the impurities. Further, crystalline organic matters were remained.

When the metal coting film was produced using the Au metal microparticles of comparative example 1 for the metal paste, the volume resistivity of the obtained Au metal coat was about 20.8 μΩcm as shown in table 2. In comparative example 1, the water-soluble impurity was remained, thus increasing the impurities, and therefore the volume resistivity of the formed metal coat was decreased. In addition, in comparative example 1, salt or the amide compound may be generated due to the protective agent, similarly to example 1. However, purification by water is not performed, and therefore probably the salt or the amide compound is not removed and remained in the metal microparticles. Then, it can be considered that the impurities contained in the metal microparticles are increased, and therefore the volume resistivity of the metal coat is decreased.

### Comparative Example 2

Comparative example 2 is different from example 1 only in a point that purification is performed by water only, and the other conditions are the same as those of example 1, to thereby produce the Au metal microparticles.

Similarly to example 1, the Au metal microparticles of comparative example 1 were measured and evaluated. As a result, according to the XRD measurement, the peak of the metal gold having the face-centered cubic (fcc), and the peak other than the Au metal (probably excessive bis(2-ethylhexyl)amine) probably which cannot be removed by water), were confirmed.

Further, as shown in table 2, according to the Au metal microparticles of comparative example 2, 0.115 mass % of Cl component, and 0.095 mass % of Na component were contained in the Cu metal microparticles powder, and halogen excluding Cl, alkali metal excluding Na, sulfur, and phosphorus were not detected. In comparative example 2, the purifying step was performed by water only, and the purifying step by the organic solvent such as hexane and methanol was not performed. Therefore, bis(2-ethylhexyl) which was not dissolved into water, was remained, and residual Cl and Na were also increased.

### Comparative Example 3

Comparative example 3 is different from example 1 only in a point that the reducing agent or the protective agent of example 1 are changed to hydrogen peroxide, and the other conditions are the same as those of example 1, to thereby produce the Au metal microparticles.

5.0 g of Au₂O₃.1.5H₂O being the metal compound (formula amount: 468.8 g/mol, contained Au weight: 4.23 g), 5.0 g of water (formula amount: 18 g/mol, amount of substance: 0.278 mol), and 1.46 g of hydrogen peroxide being the reducing agent (formula amount: 34 g/mol, amount of substance: 0.043 mol) were mixed, and were added into 100 ml eggplant-shaped flask. The concentration of the Au metal contained in this solution was about 36.9 mass %. This solution was heated at 40° C. for 10 minutes while being stirred, to reduce Au₂O₃.1.5H₂O so that a lump of the Au metal microparticless (several mm) was precipitated. Water 100 g and methanol 500 g were added into this solution, to thereby purify the Au metal microparticles. The supernatant liquid was removed, to recover the Au metal microparticles powder. The Au metal microparticles powder was dried at 40° C. for 1 hour.

In a similar measurement as example 1, the protective component on the surfaces of the Au metal microparticles was analyzed. In the IR measurement, a characteristic peak could not be confirmed. In the GC-MS measurement, water and methanol were detected. From this result, it was confirmed that the surfaces of the produced Au metal microparticles were not coated with the protective agent (the amine compound and the calboxylic acid compound), and extremely small amounts of water and methanol were adsorbed thereon.

Further, as shown in table 2, in the Au metal microparticles of comparative example 3, 0.025 mass % of Cl, and 0.02 mass % of Na were contained in the Au metal microparticles powder, and halogen excluding Cl, alkali metal excluding Na, sulfur, and phosphorus were not detected.

Although pasting of the Au metal microparticles powder was tried, the Au metal microparticles were too coarse to uniformly disperse into the solvent composition. Further, although spin-coating of the paste was tried, a continuous paste film could not be formed.

### Comparative Example 4

Comparative example 4 is different from example 1 only in a point that the reducing agent or the protective agent of example 1 are changed to acetic acid, and the other conditions are the same as those of example 1, to thereby produce the Au metal microparticles.

5.0 g of Au₂O₃.1.5H₂O being the metal compound (formula weight: 468.8 g/mol, contained Au weight: 4.23 g), and 6.45 g of acetic acid being the protective agent (molecular weight: 60.05 g/mol, amount of substance: 0.107 mol) were mixed, and added into the 100 ml eggplant shaped flask. The concentration of the Au metal contained in this solution was about 36.9 mass %. The solution was heated at 75° C. for 1.5 hour while being stirred. However, Au₂O₃.1.5H₂O was remained to be precipitated, and no change was observed. When the XRD measurement of the precipitated powder was performed, it was confirmed that the precipitated powder was Au₂O₃.1.5H₂O, and the Au metal microparticles were not generated. This is because the reducing agent was not added into the liquid phase, and generation of the metal nucleus and a nucleus growth into the metal microparticles do not occur.

### Comparative Example 5

In comparative example 5, the metal microparticles were produced by the aforementioned complex decomposing method (see patent document 4, and example 1 of Japanese Patent Laid Open Publication No. 2007-63579).

0.295 g of AuCl(S(CH₂)₂) (contained Au weight: 0.197 g, amount of substance: 0.001 mol), and 2.41 g of hexadecylamine n-C₁₆H₃₃NH₂ (amount of substance: 0.01 mol) were mixed as metal complexes, and were put into a three neck flask by PYREX. The concentration of the Au metal contained in the mixed solution was about 2.55 mass %. The mixed solution was heated at 120° C. for 1 hour, to reduce AuCl(S(CH₃)₂) and obtain the dispersion liquid of the Au metal microparticles coated with hexadecylamine. Then, n-hexane 100 g was added into this dispersion liquid, and was filtered using a filtrate of 1 μm, to thereby remove unreacted AuCl(S(CH₃)₂) particle and a course metal microparticles. Then, water 100 g and methanol 500 g were added into the recovered filtrate, and excessive hexadecylamine on the surfaces of the Au metal microparticles was removed, to thereby recover the Au metal microparticles powder. The Au metal microparticles powder was dried at 40° C. for 1 hour.

When the XRD measurement of the Au metal microparticles powder was performed, this was the Au metal having a (fcc) structure.

When the Au metal microparticles powder was dispersed again in the n-hexane solvent, a red color solution was obtained. This solution was dropped on the microgrid and was dried at a room temperature, and thereafter observed by FE-SEM. Then, the Au metal microparticles having a particle size of 5 to 20 nm were confirmed.

Further, when the impurity element contained in the Au metal microparticles and the content thereof were measured, in the Au metal microparticles of comparative example 5, 1.25 mass % of Cl component, and 3 mass % of S-component were contained in the Au metal microparticles powder. In addition, halogen excluding Cl, alkali metal, and phosphorus were not detected. In example 5, although the removing step is performed by purifying the mixed solvent, the amount of impurities contained in the formed metal microparticles is 0.1 mass % or more, because a metal complex containing S (sulfur) is used. This shows that in a case of containing the impurities, it is difficult to sufficiently remove the impurities (such as sulfur) contained in the metal microparticles, in removing the impurities by the purifying step.

Similarly to example 1, the Au metal microparticles of comparative example 5 were prepared into the Au paste, and when the Au metal coat was produced by the prepared Au paste, the volume resistivity of the obtained Au metal coat was about 29 μΩ·cm.

From the above result, it was found that Cl and S derived from AuCl(S(CH₃)₂) being raw materials, were adhered to the surfaces of the Au metal microparticles produced in comparative example 5, and it was difficult to remove them. It can be considered that the amount of impurities contained in the Au metal microparticles was increased, thus deteriorating a sintering property of the Au metal microparticles, and the volume resistivity of the produced Au metal coat was increased. When comparative example 5 and example 1 are compared, it is found that the metal microparticles of example 1 have less amounts of impurities, have an excellent sintering property, and have an excellent volume resistivity of the produced metal coat.

What is claimed is:

1. Metal microparticles with surfaces coated with a protective agent, wherein the protective agent is selected from at least one type of an amine compound and a carboxylic acid compound, and a total content of alkali metal, halogen, sulfur, and phosphorus contained in the metal microparticles is less than 0.1 mass % relative to a mass of the metal microparticles.

2. The metal microparticles according to claim 1, wherein the protective agent is composed of an amine compound and a calboxylic acid compound.

3. The metal microparticles according to claim 1, wherein the amine compound is an aliphatic amine compound represented by a general formula NH₂R¹, NHR¹R², or NR¹R²R³, in which R¹, R², and R³ indicate carbon numbers 2 to 16.

4. The metal microparticles according to claim 1, wherein the metal microparticles are composed of at least one type of gold, silver, copper, platinum, or palladium.

5. A metal paste containing the metal microparticles of claim 1 and a solvent composition.

6. The metal paste according to claim 5, wherein the solvent composition is selected from one type of water, alcohols, aldehydes, ethers, esters, amines, monosaccharide, straight-chain hydrocarbon, fatty acids, and aromatics, or a combination of them.

7. A metal coat, which is formed by sintering the metal paste of claim 5.

8. A method for producing metal microparticles, comprising the steps of:
reducing and precipitating a metal nucleus from a metal compound dispersed in a solid state, in a liquid phase containing a reducing agent and a protective agent, and agglutinating the metal nucleus, and coating the metal nucleus with the protective agent, and generating metal microparticles; and
removing alkali metal, halogen, sulfur, and phosphorus, being impurities contained in the metal microparticles;
wherein at least one type of an amine compound and a calboxylic acid compound not containing the impurities is used in the generating step, as the reducing agent and the protective agent, and
a mixed solvent of water and an organic solvent is used in the purifying step,
so that a total content of the impurities is less than 0.1 mass % relative to a mass of the metal microparticles.

9. The method for producing metal microparticles according to claim 8, wherein the amine compound and the calboxylic acid compound not containing the impurities are used in the generating step, as the protective agent.

10. The method for producing metal microparticles according to claim 8, wherein the metal compound is a metal oxide.
